(19) United States
(12) Patent Application Publication
(10) Pub. No.: US 2018/0112366 A1
(43) Pub. Date: Apr. 26, 2018

(54) EXTENDABLE BARRIER SYSTEM FOR A VEHICLE

(71) Applicant: Comprehensive Innovations, LLC, Wilmore, KY (US)

(72) Inventor: John Joseph Young, JR., Wilmore, KY (US)

(21) Appl. No.: 15/784,861

(22) Filed: Oct. 16, 2017

Related U.S. Application Data
(60) Provisional application No. 62/410,547, filed on Oct. 20, 2016.
(60) Provisional application No. 62/434,597, filed on Dec. 15, 2016.

(51) Int. Cl. E01F 13/04; B60R 21/34; B60R 19/38

(52) U.S. Cl. CPC E01F 13/048; B60R 2021/346; B60R 19/38; B60R 21/34

(57) ABSTRACT

An extendable barrier system may be used to physically prevent motorists, bicyclists, pedestrians, or other traffic from passing a vehicle such as a bus, such as while passengers are embarking or disembarking. An extendable member may laterally extend from the vehicle in a non-telescoping manner. A motor driven sprocket may drive the extendable member, such as by engaging teeth that may be present on the extendable member. One or more retainers, such as rollers, may be fixed to the frame of the vehicle, and may guide the extendable member from a retracted position to an extended position. These rollers may be fixed in place, or may be allowed some degree of movement, so that if the extendable member is struck while in the extended condition, it may disengage from the vehicle without causing significant damage. A neutral switch may maintain the vehicle in neutral or park unless the member is retracted.

This application claims priority to U.S. PROVISIONAL Application Ser. Nos. 62/410,547, filed Oct. 20, 2016, and 62/434,597, filed Dec. 15, 2016, the disclosures of which are hereby incorporated by reference in their entireties.

### TECHNICAL FIELD

This invention generally relates to a device associated with a vehicle for notification of the need to stop traffic, and more specifically to an extendable barrier for use in association with a vehicle.

### BACKGROUND OF THE INVENTION

Vehicles adapted for carrying passengers, such as buses, or more particularly school buses, must pick up and discharge said passengers. During this process, passengers may attempt to cross the road in front of the bus. Such activity poses a safety risk to the passengers, especially in the case of school children, who may be in the bus driver's blind spot, or who may not be visible to other vehicles on the road until an accident is imminent. Accordingly, for many years, school buses have been provided with warning devices and stop signs in order to signal traffic to stop when a bus is loading or unloading passengers, or when preparing to do so.

Some buses also include a gate or bar system designed to pivot away from a side of the bus in order to provide a physical barrier to vehicles that would attempt to pass the bus while the bus is loading or unloading passengers. These gates are typically hinged to the bus along a side of the bus. In a retracted state, the gate is held parallel to the side of the bus, and when deployed, the gate pivots or swings away from the bus to block at least part of an adjacent lane of traffic. One problem with such swinging or pivoting gates is the necessity for a wide berth during the extension and retraction of the gate. Another problem is that any object caught between the gate and the bus during retraction could cause the gate to dislodge from its proper positioning or cause other problems with the extension/retraction mechanism. Additionally, gates such as these may be quite heavy. The weight may cause the gate to pull away from mounts to the vehicle, or may be problematic in high-wind conditions. Furthermore, even in their retracted state, such swinging or pivoting gates add width to a vehicle such as a bus, which is already relatively wide. This added width only increases the chances of an accident due to a lateral collision with another vehicle in an adjacent lane.

At least one other example of a retractable guard for buses has been disclosed in U.S. Pat. No. 4,825,192 to Wells, which discloses a set of telescoping cylindrical members adapted to retract along a front of the bus when not in use. When in use, these members telescope outwardly in series and extend across the lane of oncoming traffic. The '192 patent requires a complex method of extraction/retraction involving a lead screw for extending the telescoping cylindrical members. Furthermore, the '192 patent requires significant mounting of a base frame to the bus, from which the telescoping members extend. In the event of another vehicle colliding with the extended guard of the '192 patent, significant damage would be incurred by the bus if the base frame were ripped therefrom.

Accordingly, a need has been identified for an extendable barrier system for a vehicle such as a school bus, which addresses these and other shortcomings of current technologies.

### SUMMARY OF THE INVENTION:

An object of the invention is to provide an extendable barrier system for use in association with a vehicle, such as a bus, van, ambulance, truck (e.g. a tractor unit, a tractor-trailer, or a garbage truck), fire engine, or police car. The system may comprise an extendable member, and at least one sprocket adapted to engage the extendable member and laterally move said extendable member along a longitudinal axis of the extendable member from a retracted position to an extended position.

The system may further include at least one roller attached to the vehicle, said roller adapted to engage the extendable member and facilitate lateral movement of the extendable member and inhibit vertical movement of the extendable member during movement from the retracted position to the extended position. The roller may include a groove adapted to receive the extendable member. In one aspect, a plurality of rollers may be provided, said plurality of rollers comprising at least one top roller attached to the vehicle on a top of the extendable member in the retracted position and at least one bottom roller attached to the vehicle on a bottom of the extendable member in the retracted position.

A motor may be provided for driving the sprocket. In one aspect, the sprocket may include a key for engaging the motor or a clutch.

In one aspect, a controller may be provided, said controller being adapted for controlling extension of the extendable member by the sprocket. The controller may be adapted to control extension of the extendable member to a fixed lateral length from a side of the vehicle. In another aspect, the controller may be adapted to control extension of the extendable member to a plurality of fixed lateral lengths from a side of the vehicle.

The extendable member may be of a fixed length. For purposes of this disclosure, the term “fixed length” is meant to reflect a member which does not increase or decrease in length, such as a telescoping member. In one aspect, the extendable member may be a solid member.

A plurality of teeth may be provided on the extendable member, said plurality of teeth adapted to engage the sprocket for the purpose of extension and retraction of the extendable member, such as from the retracted position to the extended position.

In one embodiment, an extendable barrier system is provided for use in association with a vehicle, said system comprising a trackless extendable member including a plurality of teeth along an edge of said extendable member. At least one sprocket is provided, said sprocket adapted to engage the plurality of teeth and laterally move said extendable member along a longitudinal axis of the extendable member from a retracted position along a portion of the vehicle to an extended position extending away from the vehicle. In addition, the system includes a plurality of retainers adapted to receive and guide the extendable member between the retracted position and the extended position. The extendable member is considered “trackless” because there is no track provided for retaining or guiding the extendable member, but rather only the plurality of retainers are present for guiding the extendable member between the extended and the retracted position.

The plurality of retainers of the barrier system may comprise a plurality of rollers, each roller including a groove. In one aspect, the plurality of retainers may be positioned in pairs above and below the extendable member in the retracted position.

A motor may be provided for driving the sprocket. For instance, the sprocket may include a key for engaging a shaft associated with the motor, thereby allowing the motor to drive the sprocket. A suitable clutch may also be provided for engaging the sprocket or the motor.

In one aspect, the barrier system includes a neutral switch adapted to maintain the vehicle in neutral or park unless the extendable member is in the retracted position. The extendable member may be adapted to engage the neutral switch when in the retracted position and to disengage the neutral switch when not in the retracted position.

In a further embodiment, an extendable barrier system is provided for use in association with a vehicle, the system including an extendable member adapted to extend from the vehicle from a retracted position to an extended position and a neutral switch adapted to maintain the vehicle in neutral unless the extendable member is in the retracted position. The extendable member may be a fixed length. By “fixed length,” this means that the extendable member is the same length in a retracted position and in an extended position. A fixed length member is distinguished from a telescoping member in this regard.

The extendable member of the barrier system may include a longitudinal axis which is parallel and adjacent to the vehicle in the retracted position, wherein the extendable barrier moves along said longitudinal axis when extending from the retracted position to the extended position. For example, in the retracted position, the extendable member may be positioned along the front of a bus, such as along the bumper of the bus. In the extended position, the extendable member may laterally extend along the longitudinal axis of the extendable member until it extends to the side of the bus in a manner that may block traffic in an adjoining lane.

### BRIEF DESCRIPTION OF THE DRAWINGS:

FIG. 1 is a front view of a vehicle with an extendable barrier system;

FIG. 2A is a front view of an extendable member of the extendable barrier system;

FIG. 2B is a side view of the extendable member of FIG. 2A;

FIG. 2C is a bottom view of the extendable member of FIG. 2A;

FIG. 3 is a front view of a sprocket of the extendable barrier system;

FIG. 4 is a side view of a motor of the extendable barrier system;

FIG. 5 is a side view of a retainer of the extendable barrier system;

FIG. 6A is a front view of a track system for use with an extendable barrier system;

FIG. 6B is a bottom view of the track system of FIG. 6A;

FIG. 6C is a side view of the track system of FIG. 6A;

FIG. 7 is a front view of a trackless extendable barrier system;

FIG. 8 is a detailed view of the trackless extendable barrier system of FIG. 7;

FIG. 9 is a front view of a plate for use with a break-away extendable barrier system;

FIG. 10 is a side view of the break-away extendable barrier system;

FIG. 11 is a front view of a neutral switch of an extendable barrier system; and

FIG. 12 is a bottom view of the neutral switch of FIG. 11.

### DETAILED DESCRIPTION OF THE INVENTION:

The description provided below and in regard to the figures applies to all embodiments unless noted otherwise, and features common to each embodiment are similarly shown and numbered.

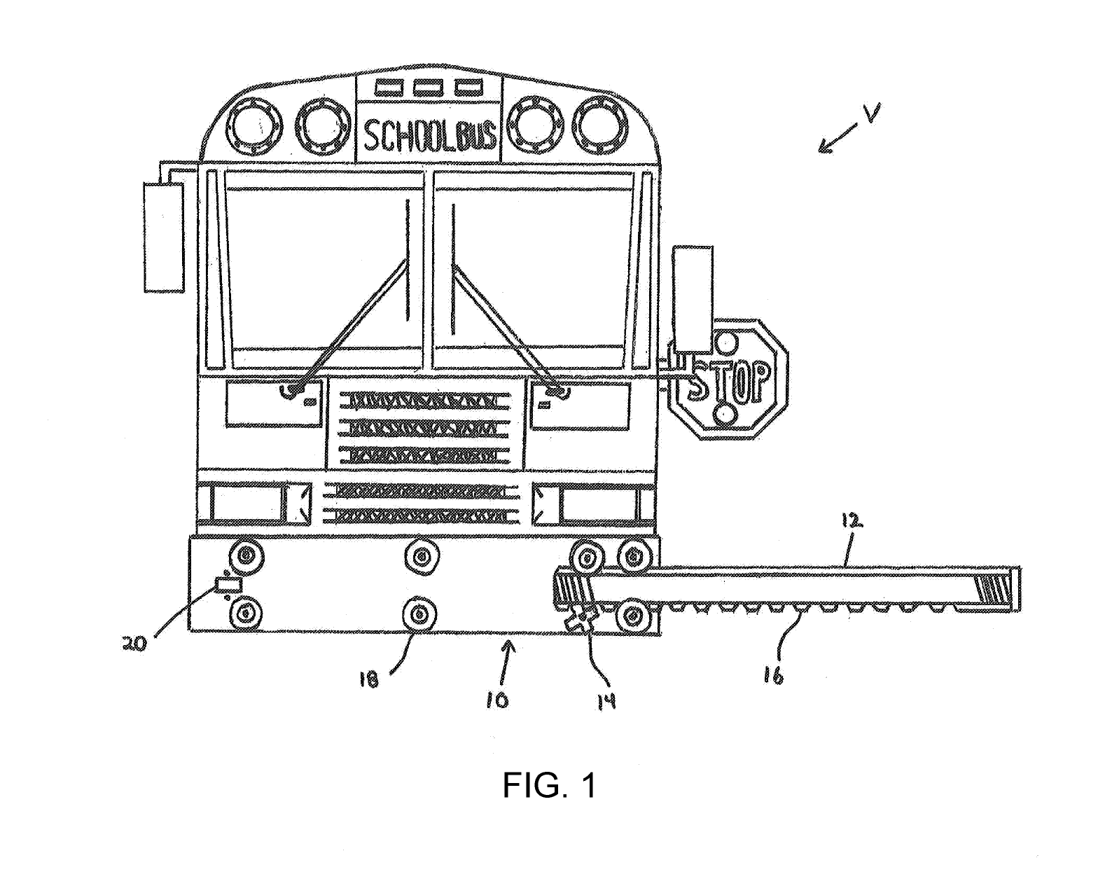

With reference to FIG. 1, an extendable barrier system 10 is disclosed for use with a vehicle V. The vehicle may be a bus, van, ambulance, truck (e.g. a tractor unit, a tractor-trailer, or a garbage truck), fire engine, or car such as a police car. More particularly, the vehicle may be a school bus. The extendable barrier system 10 may be adapted for extending outwardly from a vehicle, such as for the purpose of preventing motorists, bicyclists, pedestrians, or other traffic from passing in an adjacent lane, or for directing passengers or pedestrians along a given path with respect to the vehicle. In some embodiments, the extendable barrier system may be used for other purposes, such as for securing a dangerous scene such as a fire scene, for blocking the road at an accident, or for crowd control. In use, the extendable barrier system 10 may be adapted for use when the vehicle is stopped. A particular example of use may be in association with a school bus, such that the extendable barrier system prevents vehicles from passing a school bus when it is stopped to pick up or drop off children.

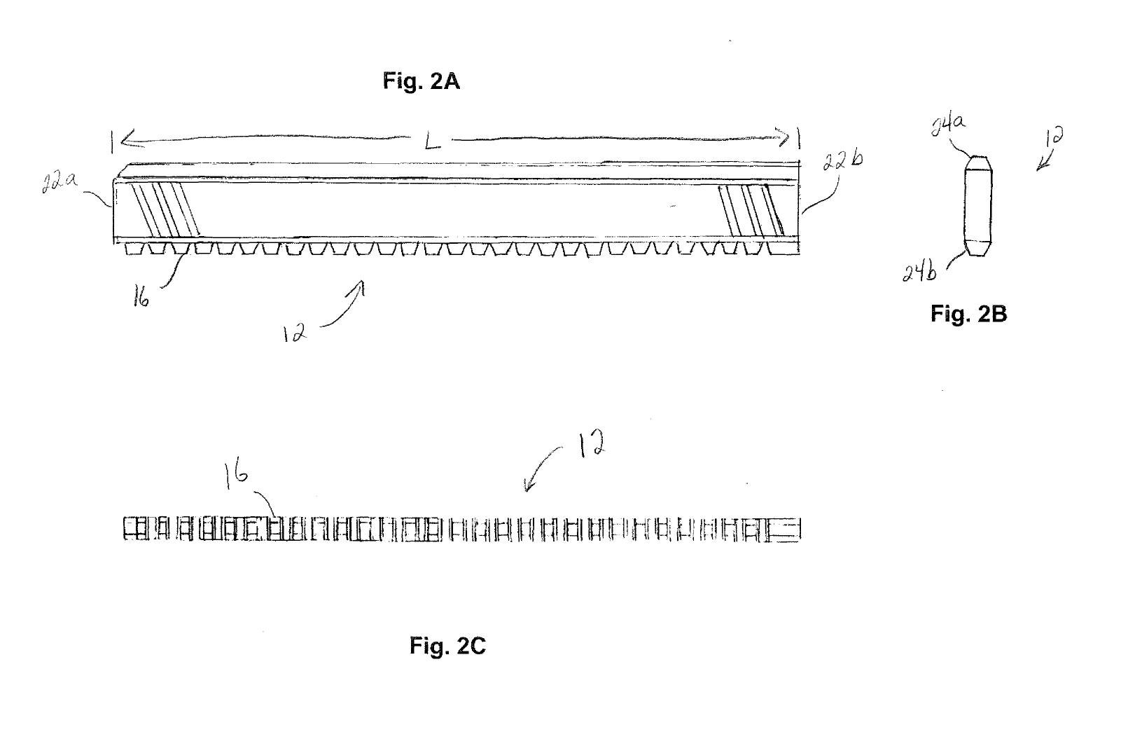

The extendable barrier system 10 may include an extendable member 12, which may be adapted for extending from a retracted position to an extended position. As can be seen in FIGS. 2A-2C, the extendable member may be in the form of a bar or beam with a fixed length L between a first side 22a and a second side 22b. As illustrated, the extendable member 12 includes generally flat front and back sides, and is taller from top-to-bottom that from front-to-back. In the illustrated embodiment, the extendable member includes an upper inclined ledge 24a and a lower inclined edge 24b, said upper and lower inclined edges adapted to facilitate movement with the remaining elements of the extendable barrier system 10 as discussed below. The extendable member 12 may comprise a solid member, such as, for example, in the case of a solid piece of material forming the extendable member.

The extendable member 12 may include one or more visual indicators. For example, a reflector may be provided for making the extendable member 12 more visible in low light conditions. The color red may be applied to the extendable member, such as in, on, or between reflectors. One or more lights may be included, such as a red light, indicating that traffic should stop. One or more signs or messages, such as a STOP sign, may be included on the extendable member 12.

In one aspect, in the retracted position, the extendable member 12 may be adjacent to the vehicle, and in the extended position, the extendable member 12 may extend away from the vehicle. For example, the extendable member 12 may be adjacent to and parallel with a front side of the vehicle, such as in line with a front bumper, when in the retracted position, and may extend outwardly from a side of the vehicle when in the extended position. In another example, the extendable member 12 may be adjacent to and parallel with a lateral side of the vehicle when in the retracted position, and may extend outwardly from a front or back of the vehicle when in the extended position.

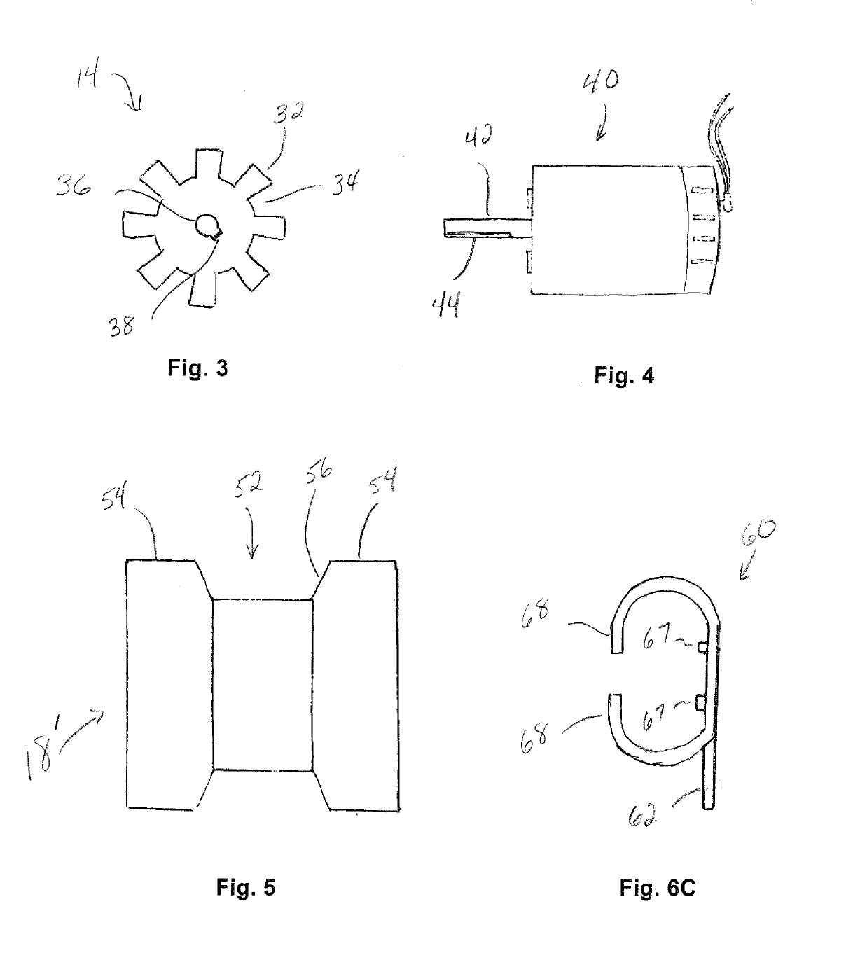

In one aspect, the extendable barrier system 10 may include at least one sprocket 14 for engaging the extendable member 12 and moving said extendable member 12 between the retracted and the extended positions. With reference to FIG. 3, an example of such a sprocket 14 is illustrated. The sprocket 14 may include one or more driving teeth 32, separated by gaps 34. Similarly, the extendable member 12 may include teeth 16, illustrated at least in FIGS. 2A and 2C, said teeth adapted to mesh with the driving teeth 32 of the sprocket 14 for movement of the extendable member 12 within the barrier system 10. The teeth 16 of the extendable member 12 may be along a top edge, a bottom edge, or both. Although only a single sprocket is present in the illustrated extendable barrier system, a plurality of sprockets may be provided, such as for engaging the extendable member 12 on the top and bottom of the extendable member. Thus, in moving between the retracted position and the extended position, the extendable member travels along its longitudinal axis.

With further reference to FIG. 3, the sprocket 14 may include an aperture 36 for receiving a drive shaft 42 of a motor 40 (see FIG. 4). The aperture 36 of the sprocket 14 may include a key 38, such as in the form of a notch. The key may be adapted for engaging an extension 44 of the drive shaft 42, thereby preventing relative rotation between the drive shaft 42 and the sprocket 14. The motor may be mounted within or behind the frame F or bumper of the vehicle, with the drive shaft 42 protruding through the frame to engage the sprocket 14.

In moving from the retracted position to the extended position, the extendable member 12 may maintain a constant length L. Accordingly, the extendable member 12 may be considered a non-telescoping member.

In a further aspect, a controller may be provided for controlling the extension of the extendable member 12 from the retracted position to the extended position. For example, the controller may dictate the speed and extent of rotation of the sprocket, thereby dictating the speed and extension length of the extendable member 12. The controller may be one of a microcontroller, a microprocessor, a computer, or any other programmable device. In one embodiment, the controller may be adapted to control extension of the extendable member to a fixed lateral length from a side of the vehicle. In another embodiment, the controller may be adapted to control extension of the extendable member 12 to a plurality of fixed lateral lengths from a side of the vehicle. For safety purposes, the controller may be adapted to prevent actuation of the sprocket 14 (and therefore prevent extension of the extendable member 12) unless the vehicle is in neutral gear. In another aspect, the controller may be adapted to prevent actuation of the sprocket 14 unless the parking break of the vehicle is engaged.

One or more retainers 18 may be provided for engaging the extendable member 12 and facilitating movement, such as lateral movement, between the retracted and extended positions. The retainers 18 may further be adapted to inhibit or prevent vertical movement of the extendable member 12, such as during said lateral movement.

In one aspect, the retainer may be in the form of a roller 18′. The rollers 18′ may be attached to the vehicle, and may be adapted for rotational movement relative thereto. With reference to FIG. 5, the roller 18′ may include a groove 52 adapted to receive the extendable member 12. The groove 52 may be at least partially defined by inclined walls 56 between outer extensions 54. For example, the roller 18′ may be shaped like a spool, with front and back extensions 54 adapted to retain the extendable member 12 therebetween. The inclined ledges 24a, 24b of the extendable member 12 may be adapted to mate with the inclined walls 56 of the roller 18′, thereby inhibiting forward and rearward movement of the extendable member 12 when engaged with the roller 18′.

As illustrated in FIG. 1, a plurality of rollers 18 may be provided for retaining the extendable member 12. The plurality of rollers 18 may be arranged in pairs along the length of the extendable member in the retracted position. The pairs of rollers may be arranged such that each pair includes an upper roller placed above the extendable member 12 and a lower roller placed below the extendable member 12, each pair of rollers positioned at a given longitudinal location along the length of the extendable member.

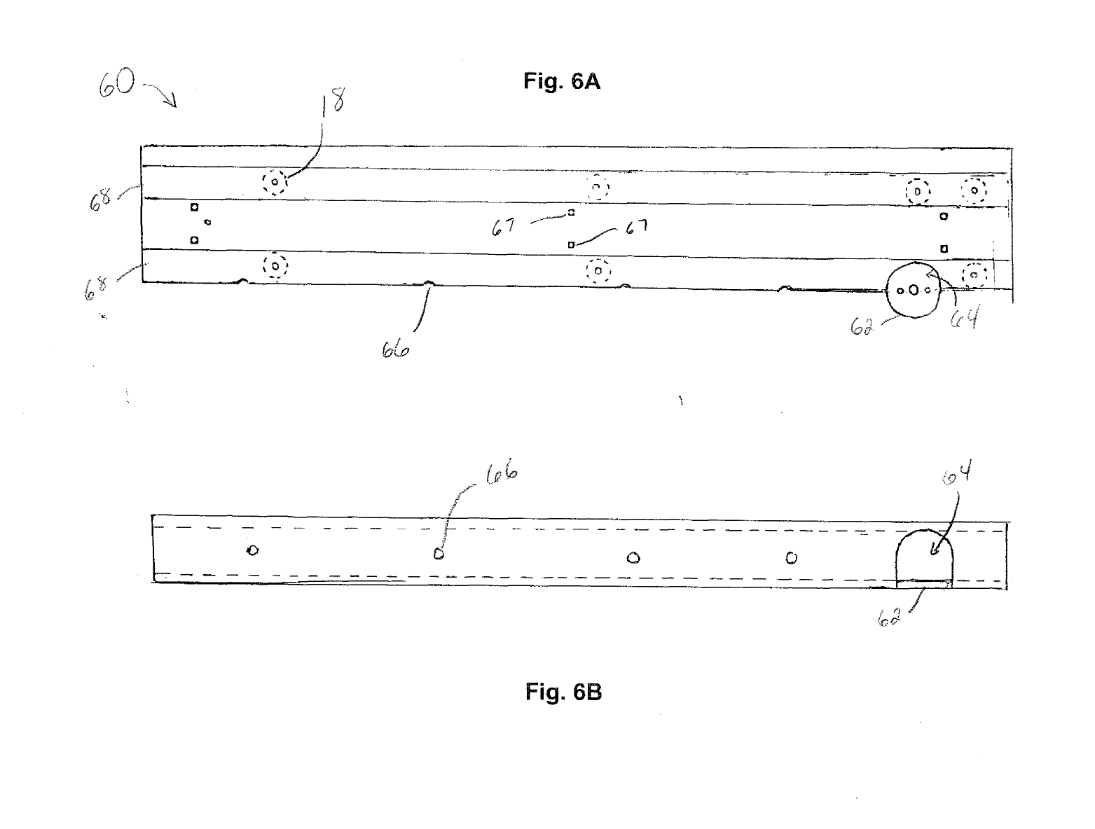

With further reference to FIGS. 6A-6C, a track 60 may be provided for further retaining and guiding the extendable member 12. The track 60 may include one or more retainers 67 for attaching the track 60 to the vehicle V. The retainers 67 may comprise bolts, pins, welds, clips, posts, sockets, or any other method of attaching the track to the vehicle. With further reference to FIG. 6C, the track 60 may be “C-shaped” and may include lips 68 for preventing the extendable member 12 from becoming detached from the extendable barrier system. In one aspect, the retainers 18 may be included within or behind the lips 68. The track 60 may include a frame extension 62, which may depend downward from the main body of the track 60, which may be used to support the sprocket 14. An aperture 64 may be provided in the track 60, such as in a lip 68, thereby providing space for the sprocket. One or more drain holes 66 may be provided in the track 60, such as for preventing water from accumulating within the track.

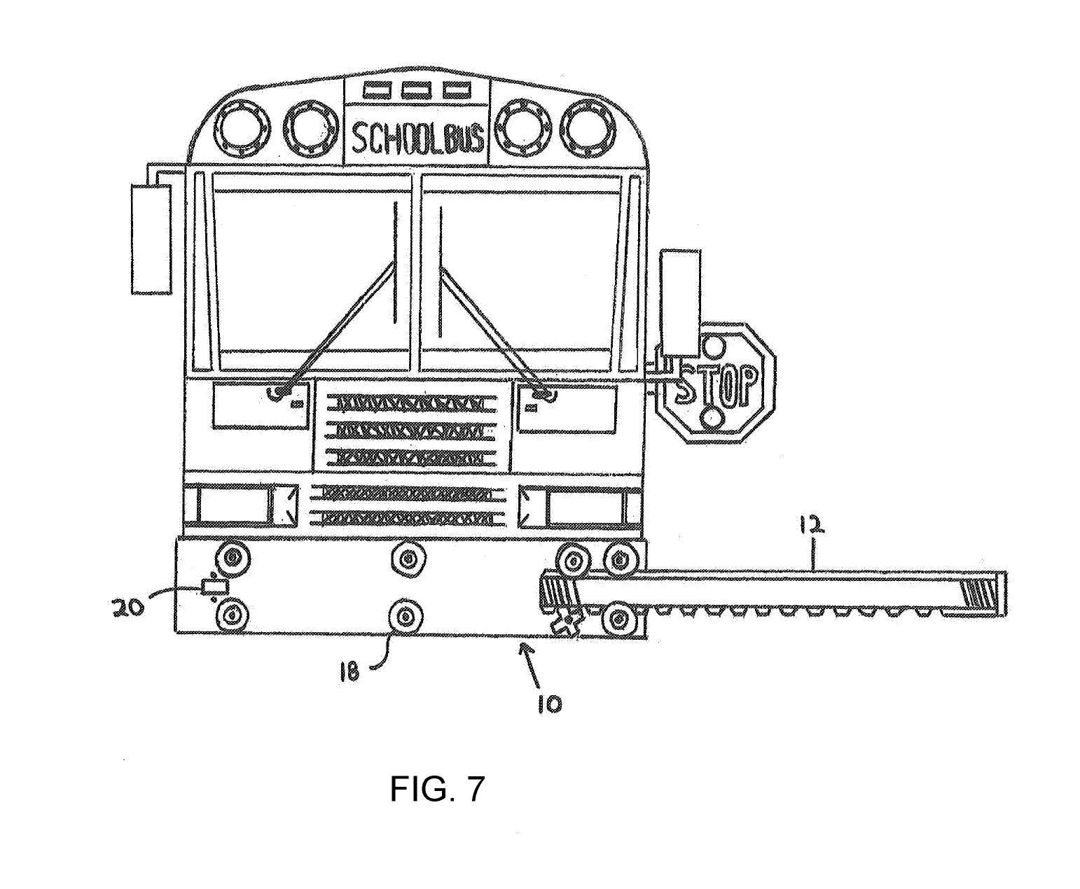

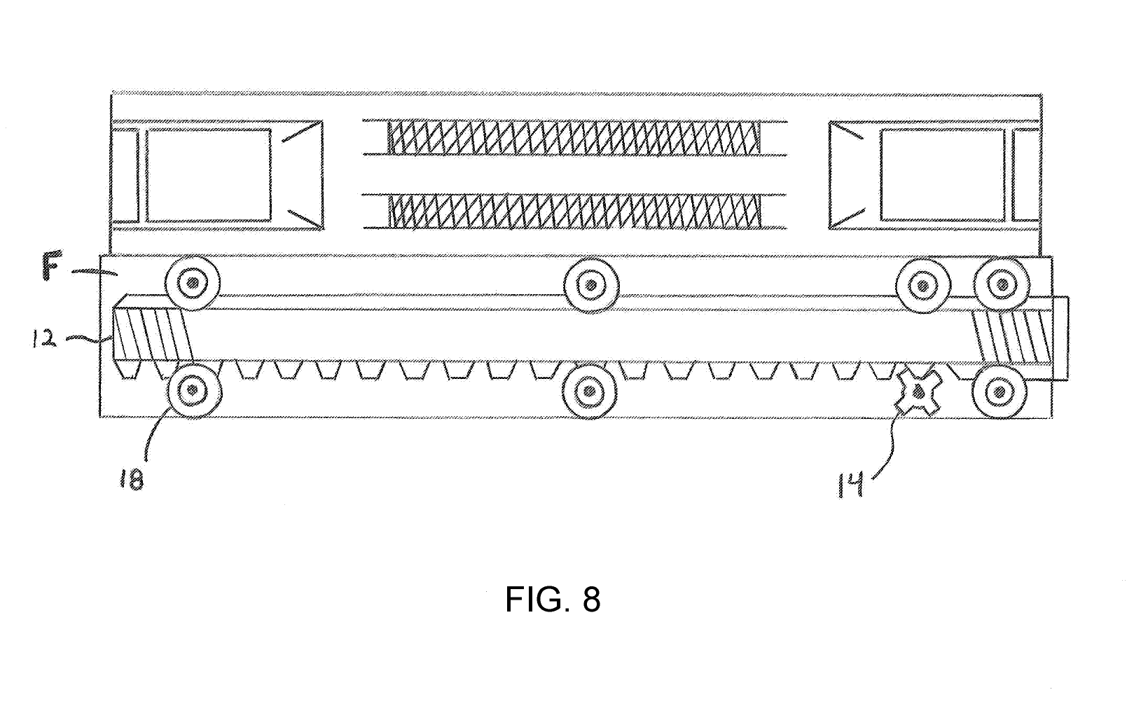

As illustrated in FIGS. 7-8, the extendable barrier system 10′ may be trackless. In the trackless extendable barrier system, no track is provided, but rather only the retainers 18 are utilized to retain and guide the extendable member 12 between the retracted position and the extended position. Any or all other elements described above, other than the track 60, may be provided in the trackless extendable barrier system 10′. For example, the retainers 18 may be attached directly to a frame F of the vehicle. A plurality of sprockets 14 may be provided with the trackless extendable barrier system in order to provide further stability for the extendable member 12.

For additional stability of the extendable member 12 in the extended position, at least two pairs of retainers may be provided adjacent one another at a first end of the extendable member in the retracted position, said first end of the extendable member being the end which traverses away from the vehicle when traveling from the retracted position to the extended position. Accordingly, when the extendable member is in the extended position, at least the said two pairs of retainers may continue to support the end of the extendable member 12 opposite the first end. In one aspect, one or more sprockets may take the place of the said two pair of retainers adjacent each other at the said first end, as illustrated in FIG. 8.

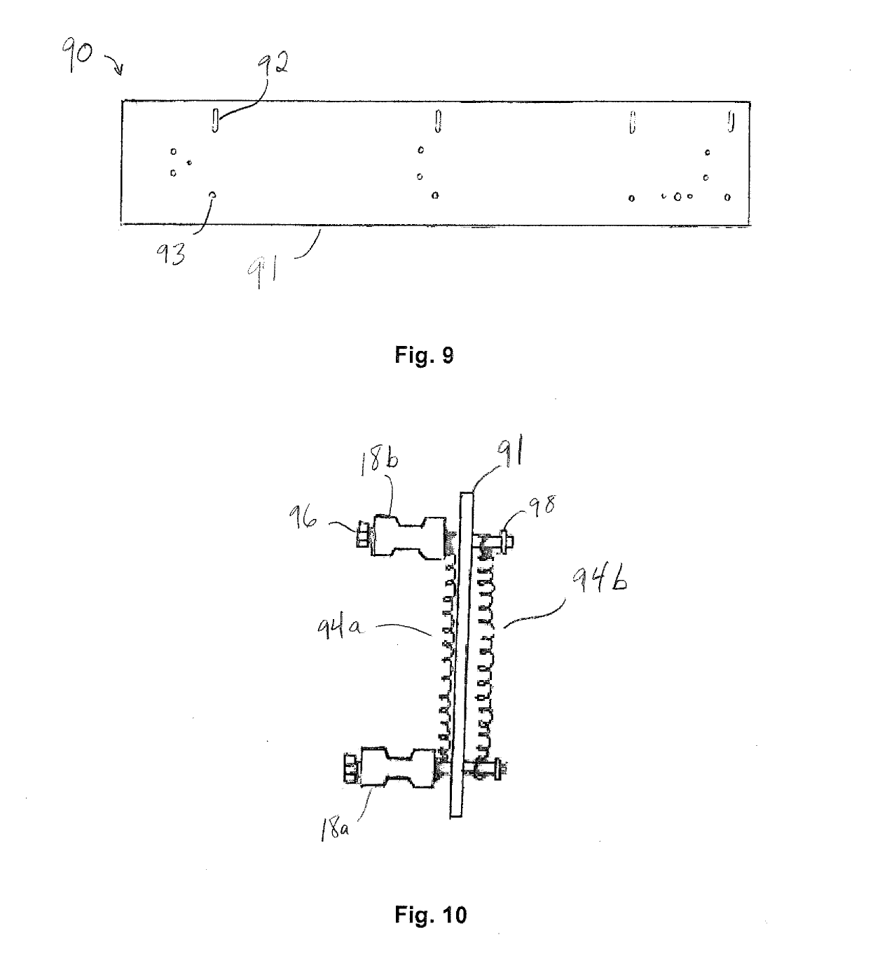

In a further aspect, a break-away system 90 is illustrated in FIGS. 9 and 10 for use with the extendable barrier system. The break-away system includes a base plate 91, which may be mounted on the vehicle, such as on, near, or parallel to a bumper of the vehicle. The break-away plate may include one or more elongate openings 92, which may be paired with one or more retention apertures 93. With further reference to FIG. 10, a lower retainer 18a may be attached to the plate 91 via one of the retention apertures 93, and an upper retainer 18b may be attached to the plate 91 via one of the elongate openings 92. For example, the retainers 18a, 18b may be attached to the plate by a fastener 96, such as a bolt, a screw, a rod, or other fastening member. In one aspect, a fixing member 98 may ensure that the fastener 96 remains attached to the plate 91. The fixing member 98 may be in the form of a nut, a pin, a clip, a clamp, or any other fixing device.

One or more tension springs 94a, 94b may attach the lower retainer 18a to the upper retainer 18b. As illustrated, a first spring 94a attaches the lower and upper retainers 18a, 18b on an exterior of the plate 91 mounted on the vehicle, and second spring 94b attaches the lower and upper retainers 18a, 18b on an interior of the plate 91. The second spring 94b may be placed inside the frame F of the vehicle. When connected, the tension springs 94a, 94b pull the lower and upper retainers 18a, 18b toward one another, thereby squeezing the extendable member 12 therebetween. In the event of a collision or other impact to the extendable member 12, the spring allows the upper retainer 18b to travel up the elongate opening 92, thereby allowing the extendable member 12 to break-away from the base plate 91. Allowing this “break-away” feature can retain the extendable member 12 in place during normal operation, but allow for dismantlement of the extendable member by force without significantly damaging the frame of the vehicle or the extendable barrier system.

In one aspect, the extendable barrier system may only be utilized when the vehicle is in neutral. For example, the controller for controlling the sprocket may be in communication with the vehicle's computer or gear control, with said sprocket controller being locked in position, thereby locking the extendable member in position, at any time the vehicle is in a gear other than neutral. Once the vehicle is shifted into neutral, the sprocket controller may be enabled. In one aspect, the sprocket controller may be adapted not to activate extension of the extendable member 12 unless the parking break is engaged.

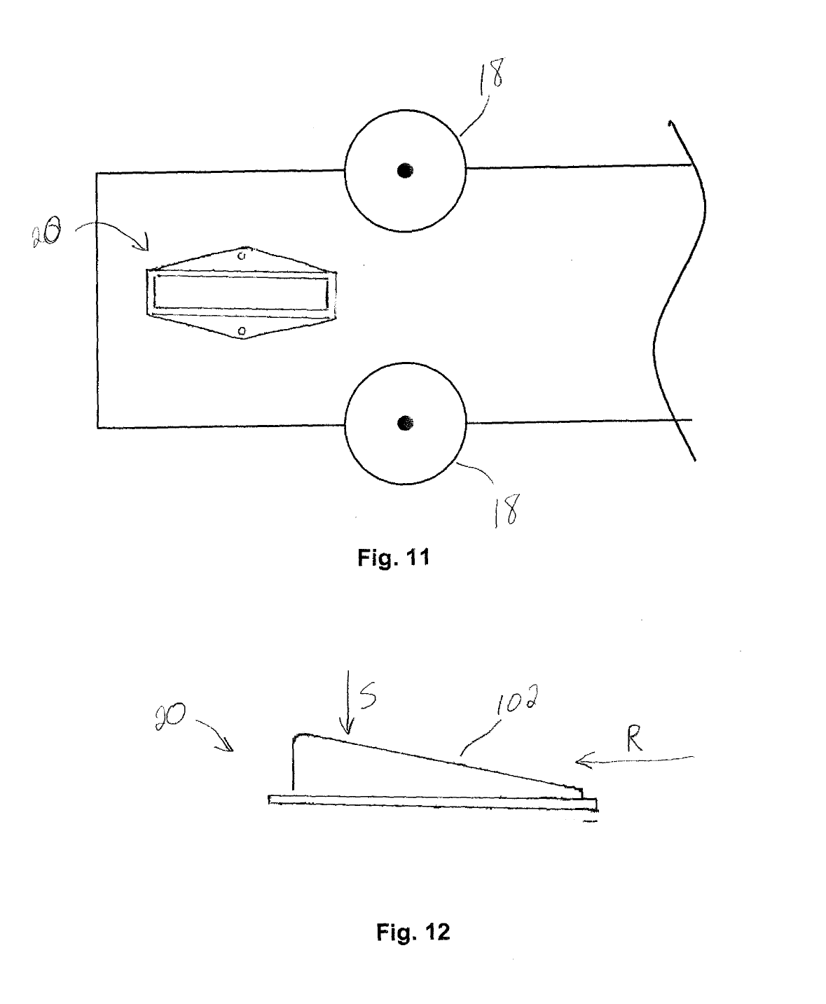

With further reference to FIGS. 1, 7, 11, and 12, a neutral switch 20 may be provided for maintaining the vehicle in neutral gear once the extendable barrier system has been engaged and the extendable member has begun being extended toward the extended position. Accordingly, the neutral switch may be adapted to maintain the vehicle in neutral gear in all conditions except when the extendable member is in the retracted position. The neutral switch may comprise any sort of electrical or mechanical switch. Neutral switch 20 may be positioned at a point along the extendable barrier system in which the extendable member may actuate the neutral switch only when the extendable member is in the retracted position. Upon initiating extension from the retracted position toward the extended position, the extendable member may disengage the neutral switch 20, thereby forcing the vehicle to remain in neutral. In one aspect, the neutral switch is connected to a gear controller, such as a microprocessor or microcontroller associated with the vehicle or the vehicle computer, which blocks engaging of the vehicle in any gear other than neutral.

As shown in FIG. 12, the neutral switch may include an inclined face 102. Neutral switch 20 may be mounted on the vehicle or any portion of the extendable barrier system such that retraction of the extendable member in the direction R applies an inward force S, thereby actuating the neutral switch. As illustrated in FIGS. 1, 7, and 11, the placement of the neutral switch 20 may be such that the extendable member 12 will only contact or actuate the neutral switch upon moving in the direction R fully into the retracted position. And as the extendable member 12 moves out of the retracted position and beyond the inclined face 102, the neutral switch 20 is released, thereby forcing the vehicle to remain in neutral gear until the extendable member is returned to the retracted position. Although the illustrated example of the neutral switch is mechanically actuated by contact with the extendable member, the neutral switch may be any sort of switch or sensor capable of determining a position of the extendable member and allowing or preventing shifting the vehicle in or out of neutral based on said position of the extendable member. For instance, the neutral switch may comprise a proximity sensor, an IR sensor, a piezoelectric sensor, an optical sensor, or any other device adapted to monitor the position of the extendable member in the retracted position.

While the invention has been described with reference to specific examples, it will be understood that numerous variations, modifications and additional embodiments are possible, and all such variations, modifications, and embodiments are to be regarded as being within the spirit and scope of the invention. Also, the drawings, while illustrating the inventive concepts, are not to scale, and should not be limited to any particular sizes or dimensions. Accordingly, it is intended that the present disclosure not be limited to the described embodiments, but that it has the full scope defined by the language of the following claims, and equivalents thereof.

1. An extendable barrier system for use in association with a vehicle, said system comprising:
an extendable member; and
at least one sprocket adapted to engage the extendable member and laterally move said extendable member along a longitudinal axis of the extendable member from a retracted position to an extended position.

2. The extendable barrier system of claim 1, further including at least one roller attached to the vehicle, said roller adapted to engage the extendable member and facilitate lateral movement of the extendable member and inhibit vertical movement of the extendable member during movement from the retracted position to the extended position.

3. The extendable barrier system of claim 1, wherein the at least one roller includes a groove adapted to receive the extendable member.

4. The extendable barrier system of claim 2, wherein the at least one roller comprises a plurality of rollers, said plurality of rollers comprising at least one top roller attached to the vehicle on a top of the extendable member and at least one bottom roller attached to the vehicle on a bottom of the extendable member.

5. The extendable barrier system of claim 1, further including a motor for driving the sprocket.

6. The extendable barrier system of claim 1, further including a controller adapted for controlling extension of the extendable member by the sprocket.

7. The extendable barrier system of claim 6, wherein the controller is adapted to control extension of the extendable member to a fixed lateral length from a side of the vehicle.

8. The extendable barrier system of claim 6, wherein the controller is adapted to control extension of the extendable member to a plurality of fixed lateral lengths from a side of the vehicle.

9. The extendable barrier system of claim 1, wherein the extendable member is a fixed length.

10. The extendable barrier system of claim 1, wherein the extendable member is a solid member.

11. The extendable barrier system of claim 1, wherein the extendable member includes a plurality of teeth for engaging the sprocket upon extension and retraction of the extendable member.

12. An extendable barrier system for use in association with a vehicle, said system comprising:
a trackless extendable member including a plurality of teeth along an edge of said extendable member;
at least one sprocket adapted to engage the plurality of teeth and laterally move said extendable member along a longitudinal axis of the extendable member from a retracted position along a portion of the vehicle to an extended position extending away from the vehicle; and
a plurality of retainers adapted to receive and guide the extendable member between the retracted position and the extended position.

13. The extendable barrier system of claim 12, wherein the plurality of retainers comprises a plurality of rollers, each roller including a groove.

14. The extendable barrier system of claim 12, wherein the plurality of retainers are positioned in pairs above and below the extendable member in the retracted position.

15. The extendable barrier system of claim 12, further including a motor for driving the sprocket.

16. The extendable barrier system of claim 12, further including a neutral switch adapted to maintain the vehicle in neutral or park unless the extendable member is in the retracted position.

17. The extendable barrier system of claim 16, wherein the extendable member is adapted to engage the neutral switch when in the retracted position and to disengage the neutral switch when not in the retracted position.

18. An extendable barrier system for use in association with a vehicle, said system comprising:
an extendable member adapted to extend from the vehicle from a retracted position to an extended position; and
a neutral switch adapted to maintain the vehicle in neutral or park unless the extendable member is in the retracted position.

19. The extendable barrier system of claim 18, wherein the extendable member is a fixed length.

20. The extendable barrier system of claim 19, wherein the extendable member includes a longitudinal axis which is parallel and adjacent to the vehicle in the retracted position, wherein the extendable barrier moves along said longitudinal axis when extending from the retracted position to the extended position.
